(19) United States
(12) Patent Application Publication
(10) Pub. No.: US 2009/0009489 A1
(43) Pub. Date: Jan. 8, 2009

(54) Portable Apparatus and Method for Inputing Data With Electronic Pen and Transmitting Data

(76) Inventor: Yong-Jik Lee, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 12/161,989

(22) PCT Filed: Jan. 24, 2007
(86) PCT No.: PCT/KR07/00422

§ 371 Date: Jul. 24, 2008

(30) Foreign Application Priority Data
Jan. 24, 2006 (KR) 10-2006-0007105
Feb. 8, 2006 (KR) 10-2006-0012153

(51) Int. Cl. G06F 3/033

(52) U.S. Cl. 345/179

(57) ABSTRACT

Disclosed is a portable apparatus and a method for inputting data with an electronic pen and transmitting data. More particularly, there is provided a portable apparatus for creating image data with an electronic pen and transmitting the created image data, or inputting data with an electronic pen, which allows a user to input numerals, characters, etc. without a keypad, and transmitting the input data, and to a data input and transmission method using such a portable apparatus.

### TECHNICAL FIELD

The present invention relates to a portable apparatus and a method for inputting data with an electronic pen and transmitting data. More particularly, the present invention relates to a portable apparatus for creating image data with an electronic pen and transmitting the created image data, or inputting data with an electronic pen, which allows a user to input numerals, characters, etc. without a keypad, and transmitting the input data, and to a data input and transmission method using such a portable apparatus.

### BACKGROUND ART

A portable apparatus refers to an information processing device, such as a PDA, a portable multimedia player (PMP), a cellular phone, a smart phone and so forth, with the aid of which a user performs various functions while freely moving.

Particularly, a portable apparatus for mobile communication, such as a cellular phone, allows a user to immediately have wireless access to and communicate with a desired party through a mobile communication base station anytime and anywhere while freely moving within the service coverage area of a mobile communication system. Since such a portable apparatus is convenient to carry and provides unhindered communication, it is getting more and more generally used. Moreover, in recent years, various supplementary functions and services, including a memo writing function, a text message transmission service, a photographing function and the like, have been steadily developed in addition to a basic service, that is, a voice call service.

Of the above-mentioned functions and services, the memo writing function is widely used in a PDA and an electronic organizer, among others, because it enables a user to take a memo of ideas suddenly occurring to him/her at ordinary times, necessary matters, things to be memorized and so forth, anytime and anywhere, without carrying writing instruments and papers with him/her, and the mobile text message transmission service is widely used because it enables a sender to simply and rapidly convey written contents by writing characters, symbols, numerals, emoticons, etc. and transmitting them to a specified party through a mobile communication base station.

However, in order to take a memo or write a text message on an existing portable apparatus, a user must go through steps of entering a memo writing mode or a text message writing mode by operating various function keys, writing contents by means of a plurality of button keys, and then storing or transmitting the written contents. Consequently, even in the case of writing a comparatively short message, a user must press a plurality of button keys through complicated steps, which results in drawbacks of inconvenient inputting and a long time required for writing. Further, since the kinds of writable characters or symbols are limited to characters or symbols already stored in a portable apparatus, there is a problem in that it is impossible for a sender to freely express various intended information and his/her own personality.

### DISCLOSURE

### Technical Problem

Accordingly, the present invention has been made to solve the above-mentioned problems occurring in the prior art, and the present invention provides a portable apparatus and a method for inputting data with an electronic pen and transmitting data, which makes it possible to simply input data and shorten a writing time by entering a memo writing mode or a message writing mode by means of the portable apparatus, writing the contents of a memo or message as if they were written down with a pen, and then storing/transmitting the written contents.

Further, the present invention provides a portable apparatus and a method for inputting data with an electronic pen and transmitting data, which makes it possible to freely express various characters or symbols just as they are naturally handwritten, irrespective of fonts and formats already stored in the portable apparatus.

Further, the present invention provides a portable apparatus and a method for inputting data with an electronic pen and transmitting data, which makes it possible to write/transmit new image data by adding contents written using the electronic pen to basic image data already stored in the portable apparatus or produced through a camera mounted on the portable apparatus.

Further, the present invention provides a portable apparatus and a method for inputting data with an electronic pen and transmitting data, which makes it possible to conduct various input functions without a keypad for inputting characters or numerals.

### Technical Solution

All terms as used herein have ordinary meanings commonly used in the relevant art, so long as they are separately defined. However, in order to clarify the present invention, some terms are defined as follows:

1) “Data input” as used herein includes inputting characters/numerals/symbols with an electronic pen, in addition to inputting characters/numerals/symbols by using a plurality of buttons in a conventional portable apparatus.

2) “Image data” as used herein refers to data including the moving path of an electronic pen, which is produced through position tracking of the electronic pen in a data processing unit, and refers not to text data including characters/numerals/symbols in the case of a conventional portable apparatus, but to data in an image format. The image format includes a bitmap format, a vector format and all other image formats capable of expressing images.

3) “Basic image data” as used herein includes: firstly, graphic files already stored in a memory unit of a portable apparatus, such as location maps, pictures and so forth; secondly, picture files newly produced through an imaging unit mounted on a portable apparatus; thirdly, existing image data created through an electronic pen and stored in a memory unit of a portable apparatus.

4) “Mapping” as used herein refers to corresponding and adding new image data created through an electronic pen to the above-mentioned basic image data. For example, assuming that a location map file is basic image data, new image data is additionally represented in a position corresponding to the basic image data by marking a destination or entering a phone number in the basic image data through an electronic pen.

In accordance with an aspect of the present invention, there is provided a portable apparatus for inputting data with an electronic pen, the portable apparatus including: a display unit; an electronic pen having a first reference signal transmitter for transmitting a first reference signal, and a second reference signal transmitter for transmitting a second reference signal running at a lower velocity than that of the first reference signal; a data input unit having a first reference signal receiver for receiving the first reference signal, two or more second reference signal receivers each for receiving the second reference signal, a second reference signal processor for calculating a reception time of the second reference signal by performing convolution operation for the received second reference signal and an already known transmitted second reference signal and performing a zero crossing analysis for a signal derived from the convolution operation, and a data processor for determining a position of the electronic pen based on reception times of the first reference signal and the second reference signals to thereby create image data; a controller unit for receiving the image data created in the data processor and displaying the received image data on the display unit; and a wireless transceiver unit for wirelessly accessing a mobile communication base station and transceiving the image data.

The second reference signal processor may include a first amplifier for amplifying the received second reference signal; an analog filter for primarily removing noise components, including a high-frequency component, from an output signal of the first amplifier; a second amplifier for amplifying an output signal of the analog filter; an AD converter for converting an output signal of the second amplifier from analog to digital; a convolution operator for performing the convolution operation; and a reception time calculator for performing the zero crossing analysis for an output signal of the convolution operator to thereby calculate the reception time of the second reference signal.

The data processor may create the image data by determining a position of the electronic pen moving on the display unit. With regard to this, the data processor preferably creates the image data in such a manner that a size of a moving path of the electronic pen corresponds one-to-one to a size of the image data displayed on the display unit.

The portable apparatus according to the present invention may further include a memory unit for storing therein and outputting therefrom the image data under a control of the controller unit.

The controller unit may display basic image data stored in the memory unit on the display unit and map the image data, which is input through the electronic pen and created in the data processor, onto the basic image data displayed on the display unit. With regard to this, the controller unit may store the basic image data, onto which the image data is mapped, in the memory unit, and transmit the stored basic image data to the mobile communication base station through the wireless transceiver unit.

The portable apparatus according to the present invention may further include an imaging unit for optoelectronically converting an image of a subject to thereby create the basic image data and transmitting the created basic image data to the controller unit.

The controller unit may output and display the mapped image data stored in the memory unit to and on the display unit, and store the mapped image data in the memory unit again after modification, deletion or addition is made to the displayed mapped image data.

The controller unit may also output and display the image data stored in the memory unit to and on the display unit, and store the image data in the memory unit again after modification, deletion or addition is made to the displayed image data.

The controller unit may also store the image data created up to a switchover of a screen of the display unit when the screen of the display unit is switched due to a different function during a process of consecutively receiving the image data created in the data processor and displaying the received image data on the display unit.

Here, the first reference signal may be any one of an infrared signal and an RF signal, and the second reference signal may be an ultrasonic signal.

In accordance with another aspect of the present invention, there is provided a method of inputting data with an electronic pen and transmitting data, the method including the steps of: driving the electronic pen to thereby transmit a first reference signal and two or more second reference signals; calculating a reception time of the second reference signal by performing convolution operation for a received second reference signal and an already known transmitted second reference signal and performing a zero crossing analysis for a signal derived from the convolution operation; determining a position of the electronic pen from reception times of the first reference signal and the second reference signals to thereby create image data; receiving the image data and displaying the received image data on a display unit; and wirelessly transmitting the image data to a mobile communication base station.

The step of calculating the reception time of the second reference signal may include the steps of: amplifying the received second reference signal; primarily removing noise components, including a high-frequency component, from the amplified signal; amplifying the signal from which the noise components are removed; converting the amplified signal from analog to digital; performing the convolution operation; and performing the zero crossing analysis for a signal derived from the convolution operation to thereby calculate the reception time of the second reference signal.

The image data may be created by determining a position of the electronic pen moving on the display unit. With regard to this, the step of creating the image data may include the step of creating the image data in such a manner that a size of a moving path of the electronic pen corresponds one-to-one to a size of the image data displayed on the display unit.

The data input and transmission method according to the present invention may further include the step of storing the image data in a memory unit. With regard to this, the method according to the present invention may further include the steps of: displaying basic image data stored in the memory unit on the display unit; and mapping the image data, which is input through the electronic pen and created in the data processor, onto the basic image data displayed on the display unit. Also, the data input and transmission method according to the present invention may further include the steps of: optoelectronically converting an image of a subject through an imaging unit to thereby create the basic image data and storing the created basic image data in the memory unit; displaying the basic image data on the display unit; and mapping the image data, which is input through the electronic pen and created in the data processor, onto the basic image data displayed on the display unit.

The data input and transmission method according to the present invention may further include the steps of: storing the mapped image data in the memory unit; and transmitting the mapped image data to the mobile communication base station through a wireless transceiver unit.

The data input and transmission method according to the present invention may further include the steps of: displaying the image data stored in the memory unit on the display unit; making a modification, deletion or addition to the displayed mapped image data; and storing the image data subjected to the modification, deletion or addition in the memory unit again.

The data input and transmission method according to the present invention may further include the step of storing the image data created up to a switchover of a screen of the display unit when the screen of the display unit is switched due to a different function during a process of consecutively receiving the image data created in the data processor and displaying the received image data on the display unit.

In accordance with yet another aspect of the present invention, there is provided a portable apparatus for inputting data with an electronic pen, the portable apparatus including: a display unit; an electronic pen for inputting data while moving on the display unit, the electronic pen having a first reference signal transmitter for transmitting a first reference signal and a second reference signal transmitter for transmitting a second reference signal running at a lower velocity than that of the first reference signal; a data input unit having a first reference signal receiver for receiving the first reference signal, two or more second reference signal receivers each for receiving the second reference signal, a second reference signal processor for calculating a reception time of the second reference signal by performing convolution operation for the received second reference signal and an already known transmitted second reference signal and performing a zero crossing analysis for a signal derived from the convolution operation, and a data processor for determining a position of the electronic pen based on reception times of the first reference signal and the second reference signals to thereby create image data; and a controller unit for receiving the image data created in the data processor and displaying the received image data on the display unit.

The portable apparatus according to the present invention may further include a box identification unit for identifying a quadrangular box within the image data; a symbol identification unit for identifying a specific symbol within the quadrangular box identified by the box identification unit; and an application unit for performing an input function using the electronic pen on the display unit under instructions from the controller unit, wherein the controller unit may control the application unit to perform the input function corresponding to the specific symbol according to a predetermined correspondence relation when the specific symbol is identified by the symbol identification unit.

Here, the specific symbol may be any one of handwritten figures and symbols including a triangle, a quadrangle, a circle, an X and a star, the input function may be performed within the quadrangular box, and the input function performed by the application unit may be any one of a numeral input function, a text input function, a free input function, an electronic dictionary input function or a calculator input function.

In accordance with still yet another aspect of the present invention, there is provided a method of inputting data with an electronic pen, the method including the steps of: driving the electronic pen on a display unit to thereby transmit a first reference signal and two or more second reference signals; calculating a reception time of the second reference signal by performing convolution operation for a received second reference signal and an already known transmitted second reference signal and performing a zero crossing analysis for a signal derived from the convolution operation; determining a position of the electronic pen from reception times of the first reference signal and the second reference signals to thereby create image data; and receiving the image data and displaying the received image data on the display unit.

The data input method according to the present invention may further include the steps of: identifying a quadrangular box within the image data; identifying a specific symbol within the quadrangular box; activating an input function corresponding to the specific symbol according to a predetermined correspondence relation when the specific symbol within the quadrangular box is identified; and performing the input function using the electronic pen on the display unit.

Scheme for Location Identification of Electronic Pen According to the Present Invention

Referring to FIG. 1a, suppose that c is the distance between second reference signal receivers 23a, 23b arranged in a row, x is the horizontal distance from the right second reference signal receiver 23b to an electronic pen 10, y is the vertical distance from each reference signal receiver 21, 23a, 23b to the electronic pen 10, b is the distance from the electronic pen 10 to the left second reference signal receiver 23a, and a is the distance from the electronic pen 10 to the right second reference signal receiver 23b. The following relations are established by the Pythagorean Theorem:

α²=x²+y² (1)

b²=(c−x)²+y² (2)

Referring to FIG. 1b, when a second reference signal is an ultrasonic signal, a can be evaluated by multiplying the speed of the ultrasonic signal by the time taken until the ultrasonic signal has reached the second reference signal receiver 23b since a first reference signal was received. Also, b can be evaluated in the same manner.

Thus, since a, b and c in Relations (1) and (2) are already known values, x and y can be evaluated by substituting the values of a, b and c into Relations (1) and (2) and solving the simultaneous equations of Relations (1) and (2). With regard to this, in order to provide the precise position identification of the electronic pen, the reception time of the second reference signal must be accurately measured.

The reception time of the second reference signal was conventionally measured by detecting an ultrasonic signal above a given threshold value, as illustrated in FIG. 1c. Errors occurring in measuring the second reference signal were empirically corrected through several repetitive measurements. However, such a conventional measurement scheme gives rise to a difference (tᵣ′−tᵣ) between the actual reception time and a measured reception time when a received ultrasonic signal contains noise, as illustrated in FIG. 1c.

Instead of the conventional measurement scheme, the present invention uses a new scheme for calculating the exact reception time of an ultrasonic signal. When the output of a transmission signal is raised or a reception signal is amplified, noise is also amplified. In this case, the transmission signal continuously maintains characteristic periodicity whereas noise has difficulty in continuously maintaining the periodicity of the transmission signal. Thus, the present invention improves the resolution of electronic pen identification by separately providing a second reference signal processor which does not respond to noise lacking the characteristic periodicity of a transmission signal, but responds to a signal which continuously maintains characteristic periodicity. Reference will now be made in detail thereto.

First, digital signal filtering is performed, in which only an effective frequency component is detected by analyzing a correlation between an already known sinusoidal transmission signal of a specific frequency and a reception signal through convolution operation therebetween. That is, digital signal filtering is carried out by performing convolution operation for the discrete signal Tₓ(k) of a sinusoidal transmission signal and the discrete signal Rₓ(k) of a reception signal, as given in the following equation:

F(k)=ΣⱼTₓ(j)Rₓ(k+1−j) (3)

Subsequently, a zero crossing analysis for a signal derived from the convolution operation is gone through to thereby detect the characteristic period of a waveform of the signal, the initial point of a region in which a certain number of the characteristic periods last is found, and then a reception time at that point is derived.

The second reference signal processor using such a scheme includes a first amplifier for amplifying a received second reference signal to such a level that the received reference signal is easily analyzed, an analog filter for primarily removing noise components, including a high-frequency component, from a signal amplified in the first amplifier, a second amplifier for amplifying an output signal of the analog filter once again, an AD converter for converting an output signal of the second amplifier from analog to digital, a convolution operator for performing convolution operation, and a reception time calculator for calculating the reception time of the second reference signal through a zero crossing analysis.

According to the above-mentioned scheme for the position identification of an electronic pen, there is an advantage in that, under the same conditions, resolution can be improved by about ten times, as compared to the existing scheme in which a reception time is estimated by responding to an ultrasonic signal above a given threshold value.

### BRIEF DESCRIPTION OF THE DRAWINGS

The above and other objects, features and advantages of the present invention will become more apparent from the following detailed description taken in conjunction with the accompanying drawings, in which:

FIGS. 1a to 1c are views illustrating a method for position identification of an electronic pen according to the present invention;

FIG. 2 is a block diagram illustrating the structure of a portable apparatus according to a first embodiment of the present invention;

FIG. 3 is a block diagram illustrating another structure of the portable apparatus according to the first embodiment of the present invention;

FIG. 4 is a front view of a portable apparatus including the structure illustrated in FIG. 2;

FIG. 5 is a front view of a portable apparatus including the structure illustrated in FIG. 3;

FIG. 6 is a block diagram illustrating the structure of a portable apparatus according to a second embodiment of the present invention;

FIG. 7 is a front view illustrating a portable apparatus including the structure illustrated in FIG. 6;

FIG. 8 is a block diagram illustrating the structure of an application unit in the portable apparatus according to the second embodiment of the present invention;

FIGS. 9a and 9b are flowcharts illustrating a data input and transmission method according to an exemplary embodiment of the present invention;

FIGS. 10a and 10b are views illustrating screens of a portable apparatus, which appear in a data input and transmission method according to an exemplary embodiment of the present invention;

FIG. 11 is a flowchart illustrating a data input method according to an exemplary embodiment of the present invention;

FIGS. 12a to 12c are views illustrating screens of a portable apparatus, which appear in a data input method according to an exemplary embodiment of the present invention; and

FIG. 13 is a view illustrating a method of inputting data not on a display unit of a portable apparatus but on a paper by using the portable apparatus of FIG. 7.

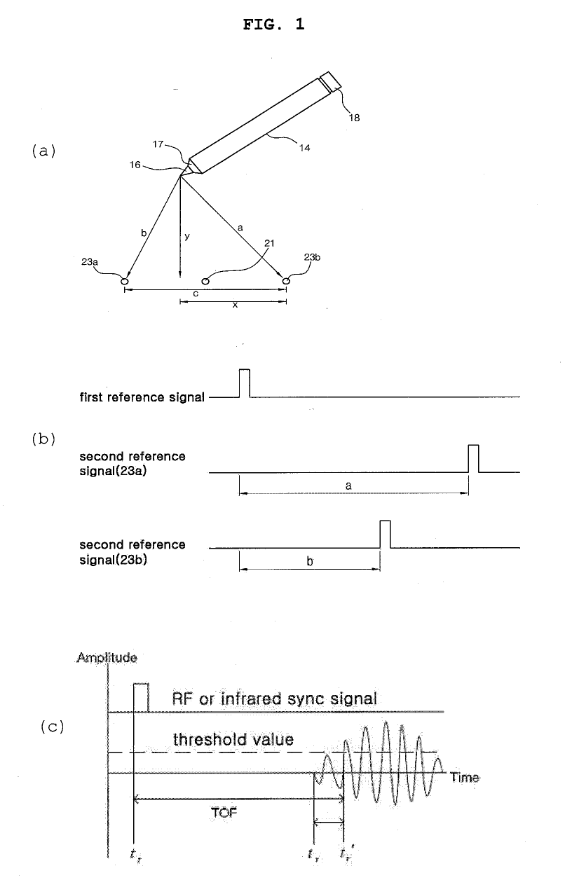

### BEST MODE

### Mode for Invention

Hereinafter, exemplary embodiments of the present invention will be described with reference to the accompanying drawings. However, these embodiments are merely illustrative, and the present invention is not limited thereto. In the following description, the same elements will be designated by the same reference numerals although they are shown in different drawings.

### Example 1

### Portable Apparatus

A portable apparatus according to a first embodiment of the present invention includes an electronic pen 10 for transmitting reference signals, a data input unit 20 for receiving the reference signals and determining a position of the electronic pen 10 to thereby create image data, a display unit 31 on which the image data is displayed, a wireless transceiver unit 37 for wirelessly accessing a mobile communication base station 105 and transceiving the image data, and a controller unit 35.

Here, the portable apparatus may further include at least one of a memory unit 39 in which/from which the image data is stored/output by the controller unit, a main body housing 1, a first connection unit 4 provided in the main body housing 1, and a second connection unit 27 provided in the data input unit 20 and electrically connected to the first connection unit 4.

Hereinafter, this embodiment will be described in detail according to its constitutional elements.

<Electronic Pen 10>

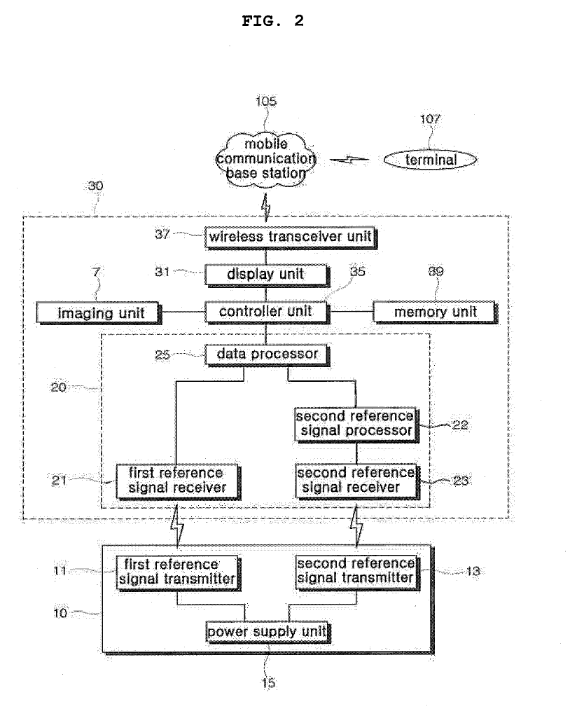

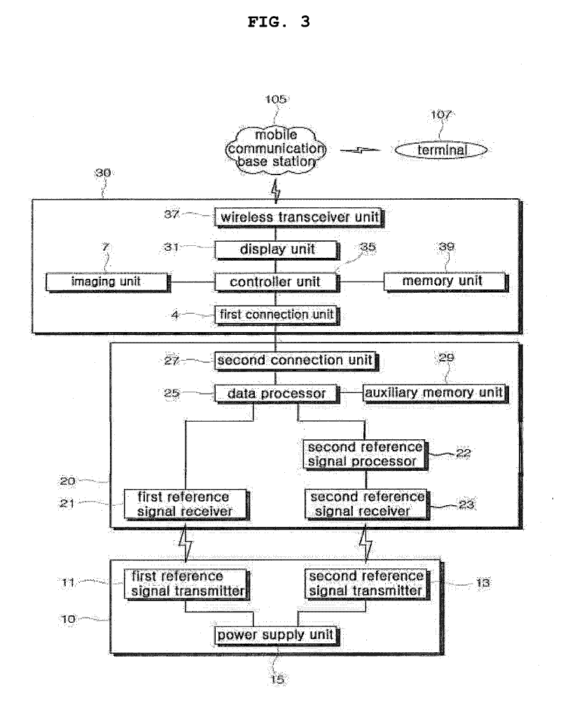

Referring to FIGS. 2 and 3, the electronic pen 10 includes a first reference signal transmitter 11 and a second reference signal transmitter 13. The electronic pen 10 may further include a power supply unit 15 for driving the first and second reference signal transmitters 11, 13.

The electronic pen 10 may have various forms. For example, it may be provided with a shape like a pencil, a ball-point pen or a fountain pen.

The first reference signal transmitter 11 is supplied with power from the power supply unit 15 and transmits a first reference signal when data input through the electronic pen 10 is selected in the portable apparatus.

The first reference signal is a sync signal for identifying a position of the electronic pen 10, and various types of signals may be used as the first reference signal, but a signal running at a higher velocity than that of a second reference signal is preferably used as the first reference signal. This is because a data processor 25 identifies a position of the electronic pen 10 by using a time interval from a point of time when the first reference signal is received to a point of time when the second reference signal is received, and thus the first reference signal must reach the data input unit 20 ahead of the second reference signal. For example, when the second reference signal is an ultrasonic signal, an infrared signal or an RF signal running at a higher velocity than that of the ultrasonic signal may be used as the first reference signal. Here, the first reference signal transmitters may vary in number according to necessity. For example, one first reference signal transmitter may be provided, or two or more first reference signal transmitters may be provided.

The second reference signal transmitter 13 is supplied with power from the power supply unit 15 and transmits a second reference signal when a data input through the electronic pen 10 is selected in the portable apparatus. Here, the number of second transmitters 13 is preferably two or more because one first reference signal transmitter 11 and two or more second reference signal transmitters 13 must be provided in order to identifying a position of the electronic pen 10. A way to identify a position of the electronic pen 10 by using the first and second reference signals has been already described above, so a description thereof will be omitted.

Various types of signals may be used as the second reference signal, but it is preferred that a signal running at a lower velocity that that of the first reference signal is used as the second reference signal. For example, when the first reference signal is an infrared signal or an RF signal, an ultrasonic signal may be used as the second reference signal.

The power supply unit 15 supplies power to the first and second reference signal transmitters 11, 13 so that the first and second reference signals can be transmitted. The power supply unit 15 may constantly supply power to the first and second reference signal transmitters 11, 13, or may supply power thereto only when data input through the electronic pen 10 begins. In the latter case, a switch 18 for manually applying or interrupting the power supply from the power supply unit 15 may be provided on one side of the electronic pen 10, or a pressure sensor may be provided at the leading end of the electronic pen 10, such that power supply from the power supply unit 15 is applied when the leading end is pressed.

<Data Input Unit 20>

As illustrated in FIGS. 2 and 3, the data input unit 20 includes a first reference signal receiver 21, a second reference signal receiver 22, a second reference signal processor 22 and a data processor 25.

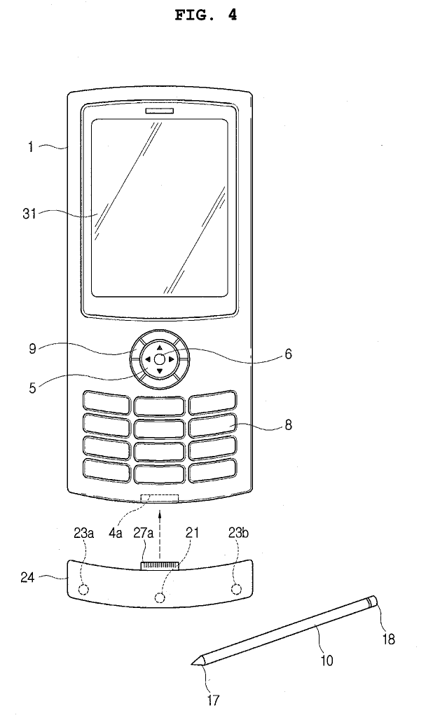

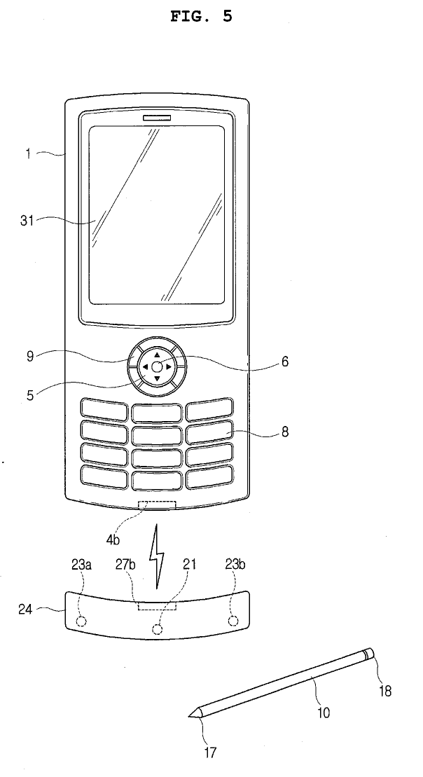

Here, the data input unit 20 may be integrally accommodated in the main body housing 1, as illustrated in FIGS. 2 and 4, or may be detachably provided in the main body housing 1, as illustrated in FIGS. 3 and 5. In the latter case, the data input unit 20 may further include at least one of the second connection unit 27 and an auxiliary memory unit 29.

The first reference signal receiver 21 is provided in such a manner as to receive the first reference signal transmitted from the first reference signal transmitter 11 of the electronic pen 10. The first reference signal receivers 21 may vary in number according to necessity. For example, one first reference signal receiver may be provided, or two or more first reference signal receivers may be provided.

The second reference signal receiver 23 is provided in such a manner as to receive the second reference signal transmitted from the second reference signal transmitter 13 of the electronic pen 10. The second reference signal receiver 23 may vary in number according to necessity, but it is preferred that two or more second reference signal receivers 23 are provided so as to enable position tracking of the electronic pen 10.

Here, the first reference signal receiver 21 and the second reference signal receivers 23a, 23b may be provided in various positions. For example, when the data input unit 20 is integrally accommodated in the main body housing 1, they may be provided in positions close to the electronic pen 10 so as to easily receive reference signals from the electronic pen 10. In contrast with this, when the data input unit 20 is provided separately from the main body housing 1, they may be provided in a separate case 24 of the data input unit 20, as illustrated in FIG. 4.

When two or more second reference signal receivers 23a, 23b are provided, they are preferably disposed on both sides at a distance within which the first reference signal receiver 21 is interposed.

The second reference signal processor 22 calculates a reception time of the second reference signal by performing convolution operation for a received second reference signal and an already known transmitted second reference signal, and performing a zero crossing analysis for a signal derived from the convolution operation.

The data processor 25 determines a position of the electronic pen 10 based on reception times of one first reference signal and two second reference signals to thereby create image data. A way to track a position of the electronic pen 10 has been already described above, so a description thereof will be omitted.

When image data is displayed by driving the electronic pen 10 on the display unit 31, the data processor 25 preferably creates image data in such a manner that the size of a moving path of the electronic pen 10 corresponds one-to-one to the size of the image data displayed on the display unit 31.

That is, if data is input by driving the electronic pen 10 on the display unit 31 in the same manner as touchpad-type data input, the input data appears on the display unit 31 in its entirety, so that a data input position can be exactly selected.

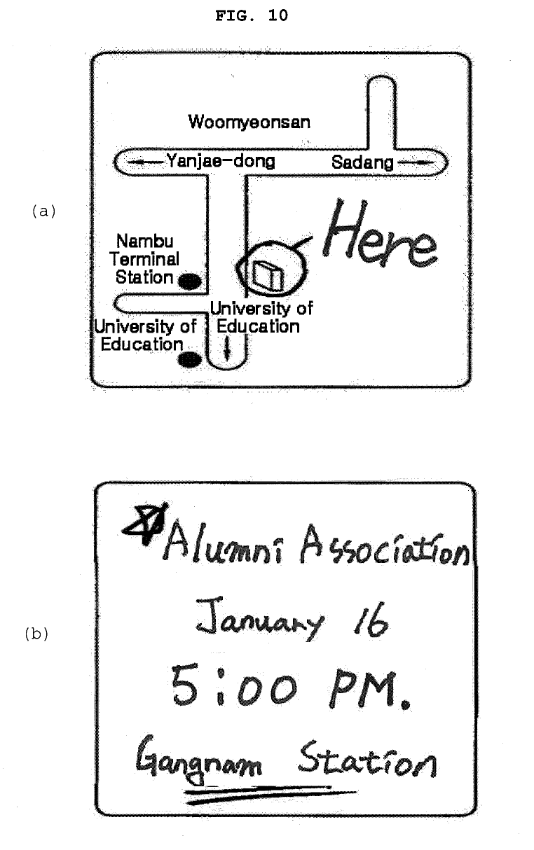

For example, let us suppose that a sender wants to inform a communication partner of his/her location information by transmitting a location map file as illustrated in FIG. 10a (here, this location map file is a picture file downloaded through the mobile communication base station 105 or photographed through an imaging unit, and corresponds to a type of basic image data having a typical format). If data is input by moving the electronic pen 10 on the display unit 31 when the sender intends to clarify or emphasize a target spot, the position of the input data can be exactly selected.

Therefore, user convenience is enhanced because a user does not have to input data multiple times due to a false position of the input data. Further, since touchpad-type data input can be employed in the portable apparatus, it is possible to implement a high-level function at low cost.

As illustrated in FIGS. 4 and 5, the case 24 is provided in such a manner as to accommodate the data processor 25, the first reference signal receiver 21 and the second reference signal receiver 23 when the data input unit 20 is separately provided outside of the main body housing 1. The case 24 may further include at least one of the auxiliary memory unit 29 and the second connection unit 27a, 27b.

The auxiliary memory unit 29 is accommodated in the case 24, and operative to store image data created in the data processor 25. By virtue of this, the image data created in the data processor 25 can be transmitted to the controller unit 35.

The second connection unit 27 is provided in such a manner as to be electrically connected with the first connection unit 4 provided in the main body housing 1 when the data input unit 20 is separately provided outside of the main body housing 1.

The second connection unit 27 may be provided in various ways. For example, when the data input unit 20 and the controller unit 35 are connected by wire, the second connection unit 27 may be provided in the form of a connector 27a disposed at one end of the main body housing 1, as illustrated in FIG. 4. When the data input unit 20 and the controller unit 35 are wirelessly connected, the second connection unit 27 may be provided in the form of a signal generator 27b for generating a wireless signal containing image data, as illustrated in FIG. 5. Here, the wireless signal may be a Bluetooth signal or an RF (Radio Frequency) signal.

<Main Body 30>

A main body 30 is the generic name of structures accommodated within the main body housing 1, and it should be noted that the main body 30 itself is of little significance in the construction of the portable apparatus.

The main body 30 includes the data input unit 20 when the data input unit 20 is integrally accommodated in the main body housing 1, as illustrated in FIG. 2, but may not include the data input unit 20 when the data input unit 20 is accommodated in the separate case 24 and the case 24 is detachably coupled with the main body housing 1, as illustrated in FIG. 3.

The display unit 31 is provided in the main body 30 in such a manner as to display image data under the control of the controller unit 35. Various schemes may be used as a scheme for displaying image data on the display unit 31, but a description thereof will be omitted because they are well known in the art.

The wireless transceiver unit 37 is provided in the main body 30 in such a manner as to wirelessly access the mobile communication base station 105 and wirelessly transmit/receive image data. The transmitted image data is transferred to another terminal 107, such as a portable apparatus, a notebook, a PDA or the like, which accesses the mobile communication base station 105.

Of course, the image data transmitted through the wireless transceiver unit 37 may be transmitted again to a subscriber accessing the mobile communication base station 105 of the same mobile communication provider, may be transmitted to a subscriber belonging to a different mobile communication provider through an interworking network with the different mobile communication provider, and may be transmitted to Internet users through the Internet network connected with a mobile communication network by using e-mail, instant messenger, etc. Further, it is obvious that the image data may be transmitted to a subscriber of a foreign mobile communication network and Internet users through an international access network.

<Controller Unit 35>

The controller unit 35 is provided in such a manner as to receive image data from the data processor 25 connected thereto, display the received image data on the display unit 31, and wirelessly transmit/receive the image data to/from the mobile communication base station 105 through the wireless transceiver unit 37. The controller unit 35 may store image data received from the data processor 25 in the memory unit 39.

When a sender intends to input a phone number/brief memo/e-mail address with the electronic pen 10 and store it or transmit it to another terminal 107, the controller unit 35 receives image data created in the data processor 25, displays it on the display unit 31, and then waits for the sender to input instructions. If the sender inputs instructions, the controller unit 35 stores the phone number/ brief memo/e-mail address in the memory unit 39 or transmits it to the mobile communication base station 105 through the wireless transceiver unit 37.

When a sender intends to write a memo in a picture photographed by the imaging unit 7 or a location map file stored in the memory unit 39 and store or transmit the picture or location map file in which the memo is written, the controller unit 35 may display basic image data received from the imaging unit 7 or basic image data stored in the memory unit 39 on the display unit 31, and map image data, which is input with the electronic pen 10, onto the basic image data displayed on the display unit 31. Subsequently, the controller unit waits for the sender to input instructions, and then stores the basic image data, onto which the input image data is mapped, in the memory unit 39 or transmits it to the mobile communication base station 105 through the wireless transceiver unit 37 if the sender inputs instructions.

Further, when a sender intends to use the portable apparatus as a pocket book/memo book/word memory card/notebook, the controller unit 35 may display basic image data stored in the memory unit 37, make a modification, deletion or addition to the displayed basic image data through the electronic pen 10, and then store the resultant basic image data in the memory unit 39 again.

The memory unit 39 is provided in the main body 30 in such a manner as to store or output image data transmitted from the data processor 25 under the control of the controller unit 35. Of course, in addition to image data, various other data, such as phone numbers, program files and so forth, can be stored in the memory unit 39.

In the case where the portable apparatus is a cellular phone, the memory unit 39 may wait for a user to input a button and then store image data when the user input the button. However, when a screen of the display unit 31 is switched due to other functions, such as answering an incoming call, etc., in the middle of creating image data, the memory unit 39 may automatically store image data created until then under the control of the controller unit 35. In this case, even if a screen of the display unit 31 is switched, image data created until then can be prevented from being lost, which results in enhanced user convenience.

<Main Body Housing 1>

The main body housing 1 is provided in such a manner as to accommodate the display unit 31, the wireless transceiver unit 37, the controller unit 35 and the memory unit 39. The main body housing 1 may further include at least one of a connection unit, a button key 8 and the imaging unit 7.

The connection unit is provided in such a manner that the controller unit 35 and the data processor 25 are electrically interconnected when the data input unit 20 is provided separately from the main body housing 1. The connection unit may include the first connection unit 4 provided in the main body housing 1 and the second connection unit 27 provided in the case 24.

The connection unit may be provided in the form of a wired connection unit as illustrated in FIG. 4, or may be provided in the form of a wireless connection unit as illustrated in FIG. 5.

When the connection unit is provided in the form of a wired connection unit, the first connection unit 4a may be provided at one end of the main body housing 1 where the case 24 is attached to or detached from the main body housing 1, and the second connection unit 27a may be provided at one end of the case 24 in such a manner as to be opposite to the first connection unit 4a, as illustrated in FIG. 4. Thus, image data created in the data processor 25 is transmitted to the controller unit 35 via the first connection unit 4a and the second connection unit 27a.

When the connection unit is provided in the form of a wireless connection unit, the connection unit may include the first connection unit 4b provided in the main body housing 1 and the second connection unit 27b provided in the case 24 and transmitting a wireless signal containing image data to the first connection unit 4b, as illustrated in FIG. 5.

Here, the wireless connection unit may employ various wireless connection schemes. For example, wireless transceiving schemes, such as an RF signal, Bluetooth and the like, may be used.

A selection key 5 is provided on one side of the main body housing 1 in such a manner as to select the access identification number of a target terminal 107 which is to receive created image data through the mobile communication base station 105.

The selection key 5 may be provided in such manner as to output already stored phone numbers on the display unit 31 and select one of them by scrolling, or may be provided in the form of number keys for inputting a new phone number.

A transmission key 6 may be provided in such a manner as to select to transmit created image data to the mobile communication base station 105.

The imaging unit 7 is provided in such a manner as to create basic image data by optoelectronically converting the image of a subject and transmit the created basic image data to the controller unit 35. Various well-known methods may be used as a scheme for optoelectrically converting the image of a subject in the imaging unit 7.

### Example 2

### Portable Apparatus

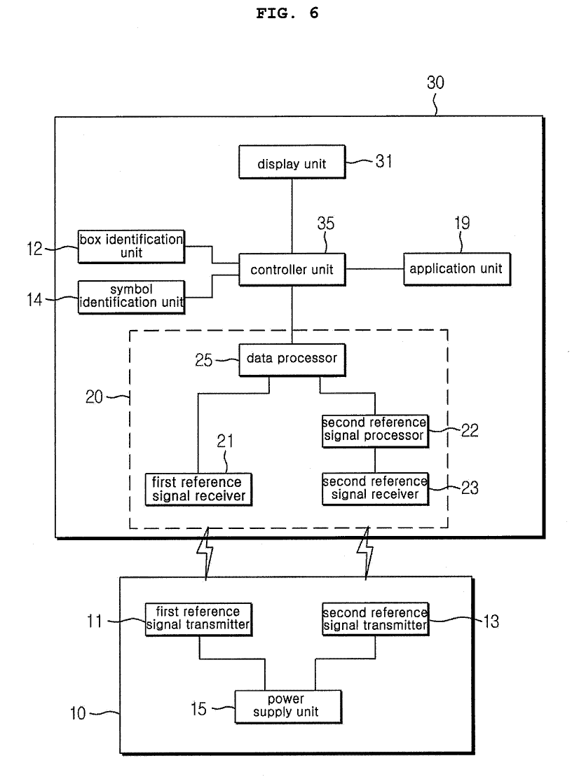

A portable apparatus according to a second embodiment of the present invention includes an electronic pen 10 for transmitting reference signals, a data input unit 20 for receiving the reference signals and determining a position of the electronic pen 10 to thereby create image data, a display unit 31 on which the image data is displayed, a controller unit 35, a box identification unit 12, a symbol identification unit 14 and an application unit 19, as illustrated in FIG. 6.

In this embodiment, a description about the same constructions as those of the above-mentioned first embodiment will be omitted, and differences from the first embodiment will be mainly described.

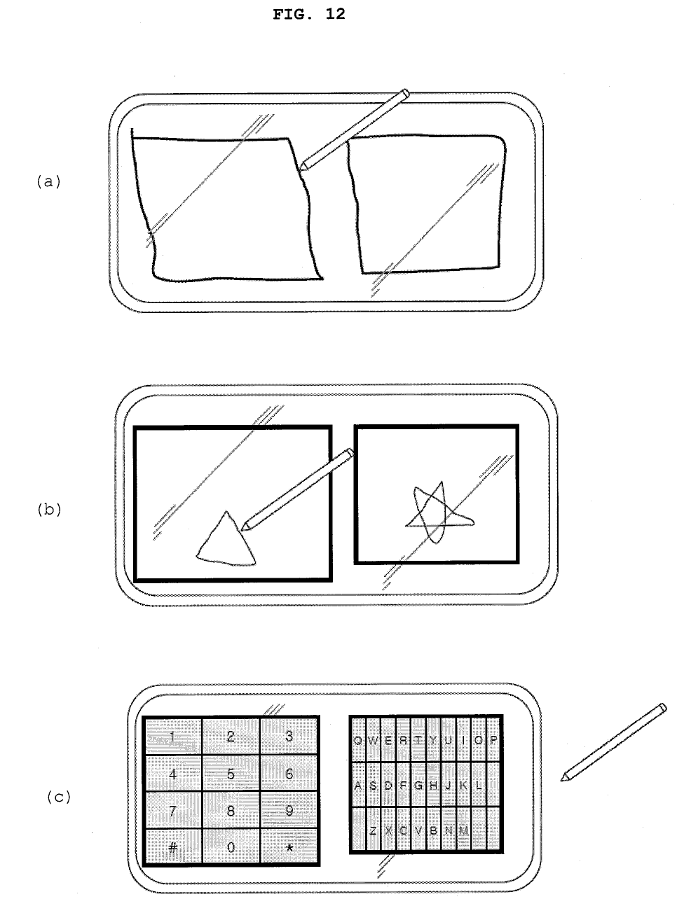

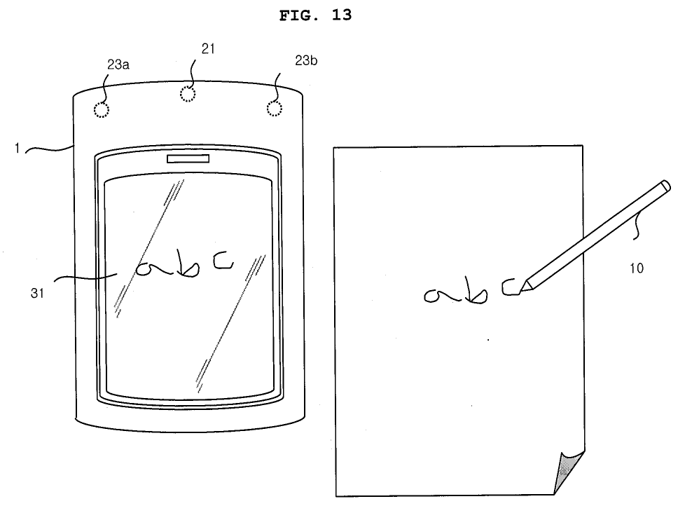

The box identification unit 12 identifies a quadrangular box within an image displayed on the display unit 31. That is, the box identification unit 12 identifies a quadrangular box when a user inputs a quadrangular box onto the display unit 31 by using the electronic pen, as illustrated in FIG. 12a. Since it is difficult for a user to input a correct quadrangular box, the box identification unit 12 is configured in such a manner as to be able to identify even a quadrangular box slightly deformed from its original shape.

The symbol identification unit 14 identifies a specific symbol within a quadrangular box identified by the box identification unit 12. That is, the symbol identification unit 14 identifies a specific symbol within a quadrangular box when a user inputs the specific symbol, such as a triangle, a quadrangle, a circle, an X, a star and so forth, within the quadrangular box by using the electronic pen as illustrated in FIG. 12b. Since it is difficult for a user to input a symbol in a correct shape, the symbol identification unit 14 is configured in such a manner as to be able to identify even a symbol slightly deformed from its original shape.

The application unit 19 performs an input function using the electronic pen 10 within a quadrangular box displayed on the display unit 31, under instructions from the controller unit 35. As illustrated in FIG. 8, the application unit 19 includes a numeral input application, a text input application, a free input application, an electronic dictionary input application and a calculator input application. Since a correspondence relation between specific symbols and input functions is predetermined, the application unit 19 performs an input function corresponding to a specific symbol identified by the symbol identification unit 14. A numeral input UI (User Interface) of a telephone is activated by the numeral input application, a QWERTY-type text input UI is activated by the text input application, a free writing UI is activated by the free input application, an electronic dictionary UI is activated by the electronic dictionary application, and a calculator UI is activated by the calculator input application.

Thus, according to the second embodiment of the present invention, various input functions can be performed in a portable apparatus without a keypad for inputting characters or numerals.

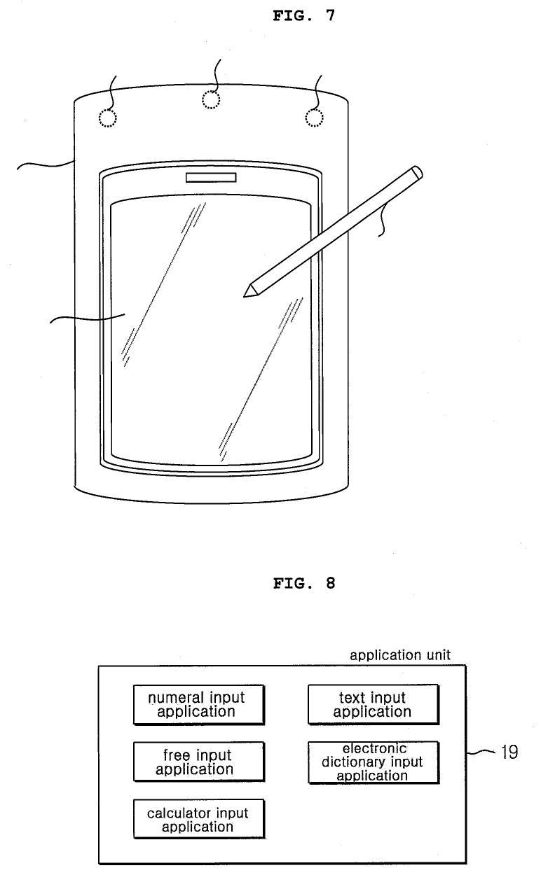

FIG. 7 illustrates a front view of a portable apparatus including the structure illustrated in FIG. 6.

Reference will now be made to embodiments of a data input and transmission method using the electronic pen 10 and a data input method using the electronic pen 10.

### Example 3

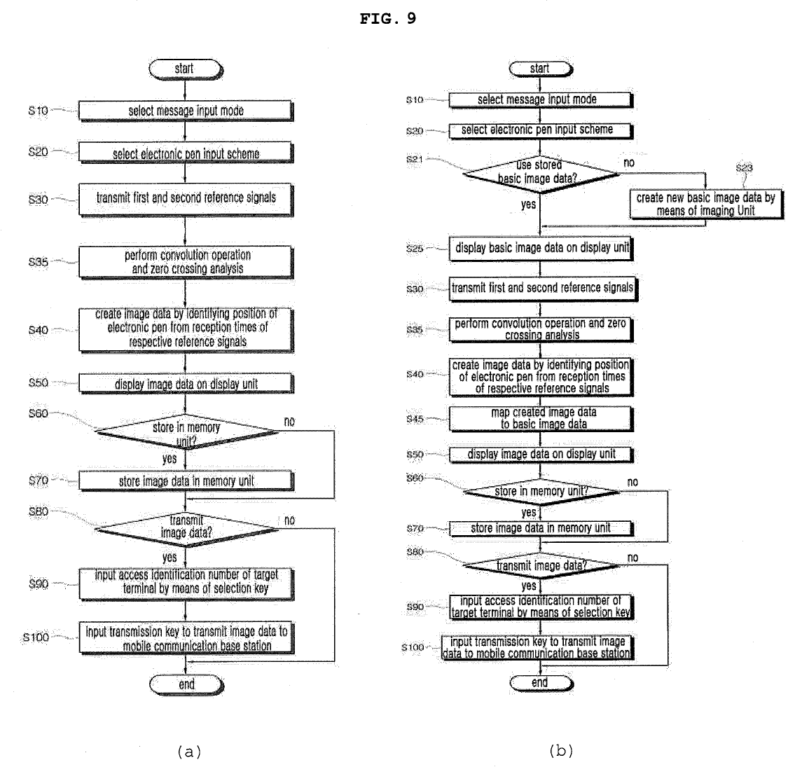

### Data Input and Transmission Method (FIG. 9)

An embodiment of a data input and transmission method illustrated in FIG. 9a is characterized by writing a phone number, a location map, a brief memo or an e-mail address with an electronic pen and then storing it or transmitting it to another terminal.

First, a sender selects a message input mode by manipulating a function key 9 provided on the front side of the main body housing 1 (S10). Next, the sender selects whether to input a message by means of the existing button key 8 or input a message with the electronic pen 10 in the message input mode (S20).

When the sender selects to input a message with the electronic pen 10, he/she drives the power supply unit 15 by operating the switch 18 of the electronic pen 10 or by pressing the leading end 17 of the electronic pen against a writing paper and thus actuating the pressure sensor, so that first and second reference signals are transmitted from the first and second reference signal transmitters 11, 13, respectively (S30).

Subsequently, a reception time of the second reference signal is calculated through convolution operation and a zero crossing analysis for a received second reference signal (S35).

The data processor 25 creates image data by identifying a position of the electronic pen 10 based on reception times of the first and second reference signals (S40).

The created image data is displayed on the display unit 31 by the controller unit 35 (S50). For example, when the sender writes message contents “★ alumni association: 5:00 PM, January 16, Gangnam Station”, as illustrated in FIG. 10b, the message contents are displayed on the display unit 31 just as they are handwritten by the sender.

Next, the sender operates the function key 9 so as to select whether to store the created image data, and the created image data is stored in the memory unit 39 when the sender selects to store it (S70, S80).

When the sender intends to transmit the image data to another person (S80), he/she selects the access identification number of a target terminal 107 from a stored phone book by means of the function key 9 and the selection key 5 or inputs a new access identification number by means of the button key 8 (S90).

Finally, if the transmission key 6 is selected, the image data is transmitted to the mobile communication base station 105 through the wireless transceiver unit 37, and transmitted to another terminal 107 accessing the mobile communication base station 105 (s100).

Further, the sender may display the stored image data on the display unit 31 again by means of the function key 9, make a modification, deletion or addition to the message contents, and then store the resultant image data again.

Thus, according to the data input and transmission method illustrated in FIG. 9a, once a sender enters the message input mode, he/she can input data with the electronic pen 10 as if he/she wrote down data, so that a memo and characters can be easily input and the time required for writing them can shorten.

Further, since a message can be freely written without limitation on the style, size and shape of characters, various contents can be expressed in the message, and a sender's feeling or personality can be effectively conveyed.

Further, since a modification, deletion or addition can be made to stored image data, the portable apparatus can be utilized as a pocket book/memo book/word memory card/notebook, and thus a user does not have to carry unnecessary writing instruments (e.g., paper and pen) with him/her, which results in enhanced user convenience.

Further, when data is input while the electronic pen moves on the display unit, a position of data to be input can be correctly selected, and it is possible to prevent data recognizability from being lowered due to the fact that input data is enlarged or reduced when displayed on the display unit 31.

Further, when data is input while the electronic pen moves on the display unit, a portable apparatus according to the present invention does not need a separate support pad for data input with the electronic pen, and thus a user carrying the portable apparatus can input data while on the move, for example, while walking around or while using public transportation, such as a bus, a subway, etc.

A data input and transmission method illustrated in FIG. 9b is characterized by additionally inserting a memo or drawing a picture into already stored basic image data or picture data photographed by a camera and then storing or transmitting the resultant picture data.

Hereinafter, a repetitive description of the same steps as those illustrated in FIG. 9a will be omitted, and differences from the steps of FIG. 9a will be mainly described.

First, a sender enters the message input mode (S10), and selects to input data with the electronic pen 10 (S20). In this state, the sender selects whether to utilize already stored basic image data or create new basic image data through the imaging unit 7 (S21).

Here, the already stored basic image data may be basic image data which has been previously photographed by the imaging unit 7 and stored in the memory unit 39 or basic image data which has been downloaded from a server of a mobile communication service provider through the mobile communication base station 105.

If the sender selects utilizing already stored basic image data, the sender only has to display the basic image data on the display unit 31 by selecting it through the function key 9 (S25). Otherwise, the sender creates new basic image data through the imaging unit 7 (s23) and then displays the created basic image data on the display unit 31 (S25).

Next, the sender inputs new image data into the basic image data displayed on the display unit 31 through the electronic pen to thereby map the new image data onto the basic image data (S30, S40, and S45).

For example, in FIG. 10a, image data, in which a note in the sender's handwriting that says “Here” is expressed along with a circle by using the electronic pen 10, can be mapped onto a location map corresponding to the basic image data.

By additionally providing a fluorescent pen function, a sign pen function or a color change function to the electronic pen 10 for image data input, image data can be more freely created.

Subsequently, the sender stores the basic image data, onto which the new image data is mapped, in the memory unit 39 (S60, S70) or transmits it to another terminal 107 via the mobile communication base station 105 by using the transmission key 6 (S100).

Of course, the sender displays the stored basic image data containing the mapped image data on the display unit 31 again, reedits it, and then stores the reedited basic image data again.

Therefore, contents intended by a sender can be more efficiently conveyed than in the case where a commonly created location map is transmitted as it is drawn, and then is verbally explained.

Although basic image data is exemplified herein by a location map file, it is not limited thereto and various picture or graphic files may be used as basic image data.

### Example 4

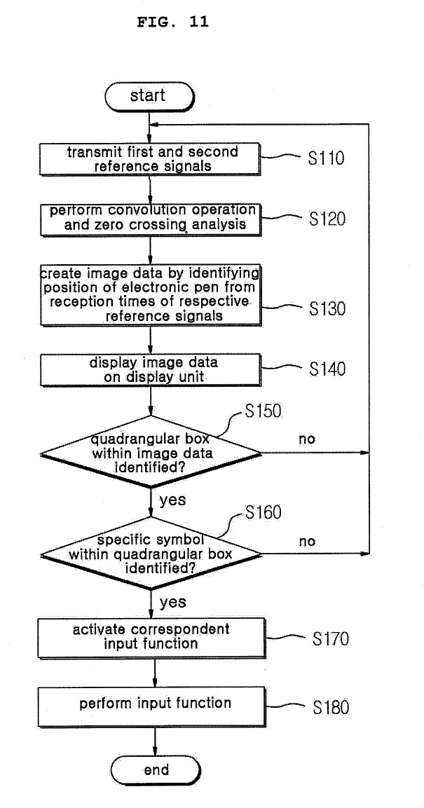

### Data Input Method (FIG. 11)

An embodiment of a data input method illustrated in FIG. 11 is characterized by the ability to perform various input functions in a portable apparatus without a keypad for inputting characters, numerals, etc.

First, if a user drives the power supply unit 15 by operating the switch 18 of the electronic pen 10 or by pressing the leading end 17 of the electronic pen against a writing paper and thus actuating the pressure sensor, first and second reference signals are transmitted from the first and second reference signal transmitters 11, 13, respectively (S110).

Subsequently, a reception time of the second reference signal is calculated through convolution operation and a zero crossing analysis for a received second reference signal (S120).

The data processor 25 creates image data by identifying a position of the electronic pen 10 based on reception times of the first and second reference signals (S130).

The created image data is displayed on the display unit 31 by the controller unit 35 (S140).

The box identification unit 12 identifies a quadrangular box within an image displayed on the display unit 31 (S150). As illustrated in FIG. 12a, when the user draws a quadrangular box on the display unit 31, the box identification unit 12 identifies the quadrangular box. If the quadrangular box is not identified, the data input method returns to S110.

If the quadrangular box is identified, the symbol identification unit 14 identifies a specific symbol within the identified quadrangular box (S160). As illustrated in FIG. 12b, when the user draws a specific symbol such as a triangle, a quadrangle, a circle, an X and a star, the symbol identification unit 14 identifies the specific symbol. If the specific symbol is not identified, the data input method returns to S110.

If the specific symbol is identified, the application unit 19 activates a correspondent input function (S170). As illustrated in FIG. 12c, a numeral input application is activated when the specific symbol is a triangle, and a QWERTY-type text input application is activated when the specific symbol is a star. Since a correspondence relation between specific symbols and input functions is predetermined, the application unit 19 activates an input function corresponding to a specific symbol according to the predetermined correspondence relation.

Subsequently, the user performs the activated input function using the electronic pen 10 on the display unit 31. That is, the user can input numerals through a numeral keypad displayed on the display unit 31 and input characters through a QWERTY keypad displayed on the display unit 31.

According to the data input method illustrated in FIG. 11, various input functions can be performed even in a portable apparatus without a keypad for inputting characters or numerals.

### Example 5

### Data Input Method (FIG. 13)

FIG. 13 illustrates an embodiment of a data input method of inputting data on a paper rather than on a display unit of a portable apparatus by using the portable apparatus. The data input method illustrated in FIG. 13 is different from the existing touchpad input method, in which data is input on a display unit of a portable apparatus, in that a user's writing can be imaged by applying an input scheme according to the present invention on a separate paper, such as scratch paper, a notebook or the like, rather than a display unit of a portable apparatus. This can be implemented because the reception ranges of the first reference signal receiver 21 and the second reference signal receivers 23a, 23b are not limited to the display unit 31 of the portable apparatus in FIG. 7.

### INDUSTRIAL APPLICABILITY

According to the present invention as described above, once a sender enters a message input mode, he/she can input data with the electronic pen 10 as if he/she wrote down data, so that a memo and characters can be easily input and the time required for writing them can shorten.

Further, since a message can be freely written without limitation on the style, size and shape of characters, various contents can be expressed in the message, and a sender's feeling or personality can be effectively informed.

Further, since a modification, deletion or addition can be made to stored image data, a portable apparatus can be utilized as a pocket book/memo book/word memory card/notebook, and thus a user does not have to carry unnecessary writing instruments (e.g., paper and pen) with him/her, which results in enhanced user convenience.

Further, since necessary contents can be freely added to a commonly created location map/picture file, and the location map/picture file with the added contents can be transmitted, the contents can be more efficiently informed than in the case where a location map is transmitted as it was drawn.

Further, since data is input while the electronic pen moves on the display unit, a position of data to be input can be correctly selected, and it is possible to prevent data recognizability from being lowered due to the fact that input data is enlarged or reduced while displayed on a display unit.

Further, various input functions can be performed in a portable apparatus without a keypad for inputting characters, numerals, etc.

Although several preferred embodiments of the present invention have been described for illustrative purposes, those skilled in the art will appreciate that various modifications, additions and substitutions are possible, without departing from the scope and spirit of the invention as disclosed in the accompanying claims.

1. A portable apparatus for inputting data with an electronic pen, the portable apparatus comprising:
a display unit;
an electronic pen having a first reference signal transmitter for transmitting a first reference signal, and a second reference signal transmitter for transmitting a second reference signal running at a lower velocity than that of the first reference signal;
a data input unit having a first reference signal receiver for receiving the first reference signal, two or more second reference signal receivers each for receiving the second reference signal, a second reference signal processor for calculating a reception time of the second reference signal by performing convolution operation for the received second reference signal and an already known transmitted second reference signal and performing a zero crossing analysis for a signal derived from the convolution operation, and a data processor for determining a position of the electronic pen based on reception times of the first reference signal and the second reference signals to thereby create image data;
a controller unit for receiving the image data created in the data processor and displaying the received image data on the display unit; and
a wireless transceiver unit for wirelessly accessing a mobile communication base station and transceiving the image data.

2. The portable apparatus as claimed in claim 1, wherein the second reference signal processor comprises:
a first amplifier for amplifying the received second reference signal;
an analog filter for primarily removing noise components, including a high-frequency component, from an output signal of the first amplifier;
a second amplifier for amplifying an output signal of the analog filter;
an AD converter for converting an output signal of the second amplifier from analog to digital;
a convolution operator for performing the convolution operation; and
a reception time calculator for performing the zero crossing analysis for an output signal of the convolution operator to thereby calculate the reception time of the second reference signal.

3. The portable apparatus as claimed in claim 1, wherein the data processor creates the image data by determining a position of the electronic pen moving on the display unit.

4. The portable apparatus as claimed in claim 3, wherein the data processor creates the image data in such a manner that a size of a moving path of the electronic pen corresponds one-to-one to a size of the image data displayed on the display unit.

5. The portable apparatus as claimed in claim 1, further comprising a memory unit for storing therein and outputting therefrom the image data under a control of the controller unit.

6. The portable apparatus as claimed in claim 5, wherein the controller unit displays basic image data stored in the memory unit on the display unit, and maps the image data, which is input through the electronic pen and created in the data processor, onto the basic image data displayed on the display unit.

7. The potable apparatus as claimed in claim 6, wherein the controller unit stores the basic image data, onto which the image data is mapped, in the memory unit, and transmits the stored basic image data to the mobile communication base station through the wireless transceiver unit.

8. The portable apparatus as claimed in claim 1, further comprising an imaging unit for optoelectronically converting an image of a subject to thereby create the basic image data and transmitting the created basic image data to the controller unit.

9. The portable apparatus as claimed in claim 7, wherein the controller unit outputs and displays the mapped image data stored in the memory unit to and on the display unit, and stores the mapped image data in the memory unit again after modification, deletion or addition is made to the displayed mapped image data.

10. The portable apparatus as claimed in claim 5, wherein the controller unit outputs and displays the image data stored in the memory unit to and on the display unit, and stores the image data in the memory unit again after modification, deletion or addition is made to the displayed image data.

11. The portable apparatus as claimed in claim 5, wherein the controller unit stores the image data created up to a switchover of a screen of the display unit when the screen of the display unit is switched due to a different function during a process of consecutively receiving the image data created in the data processor and displaying the received image data on the display unit.

12. The portable apparatus as claimed in claim 1, wherein the first reference signal comprises any one of an infrared signal and an RF signal.

13. The portable apparatus as claimed in claim 1, wherein the second reference signal comprises an ultrasonic signal.

14. A method of inputting data with an electronic pen and transmitting data, the method comprising the steps of:
driving the electronic pen to thereby transmit a first reference signal and two or more second reference signals;
calculating a reception time of the second reference signal by performing convolution operation for a received second reference signal and an already known transmitted second reference signal and performing a zero crossing analysis for a signal derived from the convolution operation;
determining a position of the electronic pen from reception times of the first reference signal and the second reference signals to thereby create image data;
receiving the image data and displaying the received image data on a display unit; and
wirelessly transmitting the image data to a mobile communication base station.

15. The method as claimed in claim 14, wherein the step of calculating the reception time of the second reference signal comprises the steps of:
amplifying the received second reference signal;
primarily removing noise components, including a high-frequency component, from the amplified signal;
amplifying the signal from which the noise components are removed;
converting the amplified signal from analog to digital;
performing the convolution operation; and
performing the zero crossing analysis for a signal derived from the convolution operation to thereby calculate the reception time of the second reference signal.

16. The method as claimed in claim 14, wherein the image data is created by determining a position of the electronic pen moving on the display unit.

17. The method as claimed in claim 16, wherein the step of creating the image data comprises the step of creating the image data in such a manner that a size of a moving path of the electronic pen corresponds one-to-one to a size of the image data displayed on the display unit.

18. The method as claimed in claim 14, further comprising the step of storing the image data in a memory unit.

19. The method as claimed in claim 18, further comprising the steps of:
displaying basic image data stored in the memory unit on the display unit; and
mapping the image data, which is input through the electronic pen and created in the data processor, onto the basic image data displayed on the display unit.

20. The method as claimed in claim 18, further comprising the steps of:
optoelectronically converting an image of a subject through an imaging unit to thereby create the basic image data and storing the created basic image data in the memory unit;
displaying the basic image data on the display unit; and
mapping the image data, which is input through the electronic pen and created in the data processor, onto the basic image data displayed on the display unit.

21. The method as claimed in claim 19, further comprising the steps of:
storing the mapped image data in the memory unit; and
transmitting the mapped image data to the mobile communication base station through a wireless transceiver unit.

22. The method as claimed in claim 18, further comprising the steps of:
displaying the image data stored in the memory unit on the display unit;
making a modification, deletion or addition to the displayed image data; and
storing the image data subjected to the modification, deletion or addition in the memory unit again.

23. The method as claimed in claim 18, further comprising the step of storing the image data created up to a switchover of a screen of the display unit when the screen of the display unit is switched due to a different function during a process of consecutively receiving the image data created in the data processor and displaying the received image data on the display unit.

24. A portable apparatus for inputting data with an electronic pen, the portable apparatus comprising:
a display unit;
an electronic pen for inputting data while moving on the display unit, the electronic pen having a first reference signal transmitter for transmitting a first reference signal and a second reference signal transmitter for transmitting a second reference signal running at a lower velocity than that of the first reference signal;
a data input unit having a first reference signal receiver for receiving the first reference signal, two or more second reference signal receivers each for receiving the second reference signal, a second reference signal processor for calculating a reception time of the second reference signal by performing convolution operation for the received second reference signal and an already known transmitted second reference signal and performing a zero crossing analysis for a signal derived from the convolution operation, and a data processor for determining a position of the electronic pen based on reception times of the first reference signal and the second reference signals to thereby create image data; and
a controller unit for receiving the image data created in the data processor and displaying the received image data on the display unit.

25. The portable apparatus as claimed in claim 24, wherein the second reference signal processor comprises:
a first amplifier for amplifying the received second reference signal;
an analog filter for primarily removing noise components, including a high-frequency component, from an output signal of the first amplifier;
a second amplifier for amplifying an output signal of the analog filter;
an AD converter for converting an output signal of the second amplifier from analog to digital;
a convolution operator for performing the convolution operation; and
a reception time calculator for performing the zero crossing analysis for an output signal of the convolution operator to thereby calculate the reception time of the second reference signal.

26. The portable apparatus as claimed in claim 24, wherein the first reference signal comprises any one of an infrared signal and an RF signal.

27. The portable apparatus as claimed in claim 24, wherein the second reference signal comprises an ultrasonic signal.

28. The portable apparatus as claimed in claim 24, further comprising:
a box identification unit for identifying a quadrangular box within the image data;
a symbol identification unit for identifying a specific symbol within the quadrangular box identified by the box identification unit; and
an application unit for performing an input function using the electronic pen on the display unit under instructions from the controller unit,
wherein the controller unit may control the application unit to perform the input function corresponding to the specific symbol according to a predetermined correspondence relation when the specific symbol is identified by the symbol identification unit.

29. The portable apparatus as claimed in claim 28, wherein the specific symbol comprises any one of handwritten figures and symbols including a triangle, a quadrangle, a circle, an X and a star.

30. The method as claimed in claim 29, wherein the input function is performed within the quadrangular box.

31. The method as claimed 28, wherein the input function performed by the application unit comprises any one of a numeral input function, a text input function, a free input function, an electronic dictionary input function or a calculator input function.

32. A method of inputting data with an electronic pen, the method comprising the steps of:
driving the electronic pen on a display unit to thereby transmit a first reference signal and two or more second reference signals;
calculating a reception time of the second reference signal by performing convolution operation for a received second reference signal and an already known transmitted second reference signal and performing a zero crossing analysis for a signal derived from the convolution operation;
determining a position of the electronic pen from reception times of the first reference signal and the second reference signals to thereby create image data; and
receiving the image data and displaying the received image data on the display unit.

33. The method as claimed in claim 32, wherein the step of calculating the reception time of the second reference signal comprises the steps of:
amplifying the received second reference signal;
primarily removing noise components, including a high-frequency component, from the amplified signal;
amplifying the signal from which the noise components are removed;
converting the amplified signal from analog to digital;
performing the convolution operation; and
performing the zero crossing analysis for a signal derived from the convolution operation to thereby calculate the reception time of the second reference signal.

34. The method as claimed in claim 32, further comprising the steps of:
identifying a quadrangular box within the image data;
identifying a specific symbol within the quadrangular box;
activating an input function corresponding to the specific symbol according to a predetermined correspondence relation when the specific symbol within the quadrangular box is identified; and
performing the input function using the electronic pen on the display unit.

35. The portable apparatus as claimed in claim 34, wherein the specific symbol comprises any one of handwritten figures and symbols including a triangle, a quadrangle, a circle, an X and a star.

36. The method as claimed in claim 35, wherein the input function is performed within the quadrangular box.

37. The method as claimed 34, wherein the input function performed by the application unit comprises any one of a numeral input function, a text input function, a free input function, an electronic dictionary input function or a calculator input function.

38. The method as claimed in claim 20, further comprising the steps of:
storing the mapped image data in the memory unit; and
transmitting the mapped image data to the mobile communication base station through a wireless transceiver unit.
